(19) United States
(12) Patent Application Publication
(10) Pub. No.: US 2006/0256520 A1
(43) Pub. Date: Nov. 16, 2006

(54) Electronic device with heat dissipation module

(75) Inventor: Yung-Shun Chen, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/250,042

(22) Filed: Oct. 13, 2005

(30) Foreign Application Priority Data
May 11, 2005 (TW) 94115187

(51) Int. Cl. G06F 1/20

(52) U.S. Cl. 361/687

(57) ABSTRACT

An electronic device. The electronic device includes a circuit board, a central processing unit, a chipset, a first heat dissipation module, a second heat dissipation module, and a fan. The central processing unit and the chipset are disposed on the circuit board. The first heat dissipation module is disposed on the central processing unit. The second heat dissipation module is disposed on the chipset. The fan is disposed on the circuit board. The fan abuts the first heat dissipation module. The first heat dissipation module abuts the second heat dissipation module.

### BACKGROUND

The invention relates to an electronic device with a heat dissipation module, and in particular, to an electronic device with a heat dissipation module providing increased heat dissipation efficiency.

When functions provided by various electronic devices increase, the number of chips also increases on the circuit board. Thus, efficiency of the central processing unit (CPU) becomes important. To improve CPU efficiency, the operating speed of CPU must be increased, causing heat generated by associated electronic devices increase, and require improved heat dissipation efficiency.

Additionally, as electronic devices are miniaturized, the size of circuit boards is also becoming miniaturized. Two different heat dissipation modules are required by the CPU and chipset respectively but neither provides enhanced heat dissipation efficiency for CPU. In addition, requiring two fans occupies greater space and increases the weight of electronic devices. Thus, electronic devices are not capable of being miniaturized.

### SUMMARY

The invention provides one fan combined with two heat dissipation modules, which can enhance CPU heat dissipation efficiency.

Accordingly, an electronic device with a heat dissipation module is provided. The electronic device comprises a circuit board, a central processing unit, a chipset, a first heat dissipation module, a second heat dissipation module, and a fan. The central processing unit is disposed on the circuit board. The chipset is disposed on the circuit board. The first heat dissipation module is disposed on the central processing unit. The second heat dissipation module is disposed on the chipset. The fan is disposed on the circuit board, and abuts the first heat dissipation. The first heat dissipation module abuts the second heat dissipation module.

Furthermore, the first heat dissipation module comprises a first heat pipe and a first heat exchanger, and the second heat dissipation module comprises a second heat pipe and a second heat exchanger. The first heat pipe abuts the central processing unit, and connects to the first heat exchanger. The first heat pipe is adhered to the first heat exchanger. The second heat pipe abuts the chipset, and connects to the second heat exchanger. The second heat pipe is adhered to the second heat exchanger. The first heat exchanger has a plurality of the first fins. The second heat exchanger has a plurality of the second fins.

The electronic device further comprises a first interval between any two adjacent first fins and a second interval between any two adjacent second fins. The second fins of the second heat exchanger are arranged to form an indentation, which forms a gap between the first fins and the second fins.

Note that the top view shows that the indentation is U-shaped or V-shaped. The electronic device is a notebook computer.

### DESCRIPTION OF THE DRAWINGS

The invention can be more fully understood by reading the subsequent detailed description and examples with references made to the accompanying drawings, wherein:

FIG. 1 is a plan schematic view of an embodiment of an electronic device;

FIG. 2 is a side view of part of a heat dissipation module in FIG. 1;

FIG. 3 is another side view of part of the heat dissipation module in FIG. 1; and

FIG. 4 is another side view of part of the heat dissipation module in FIG. 1.

### DETAILED DESCRIPTION

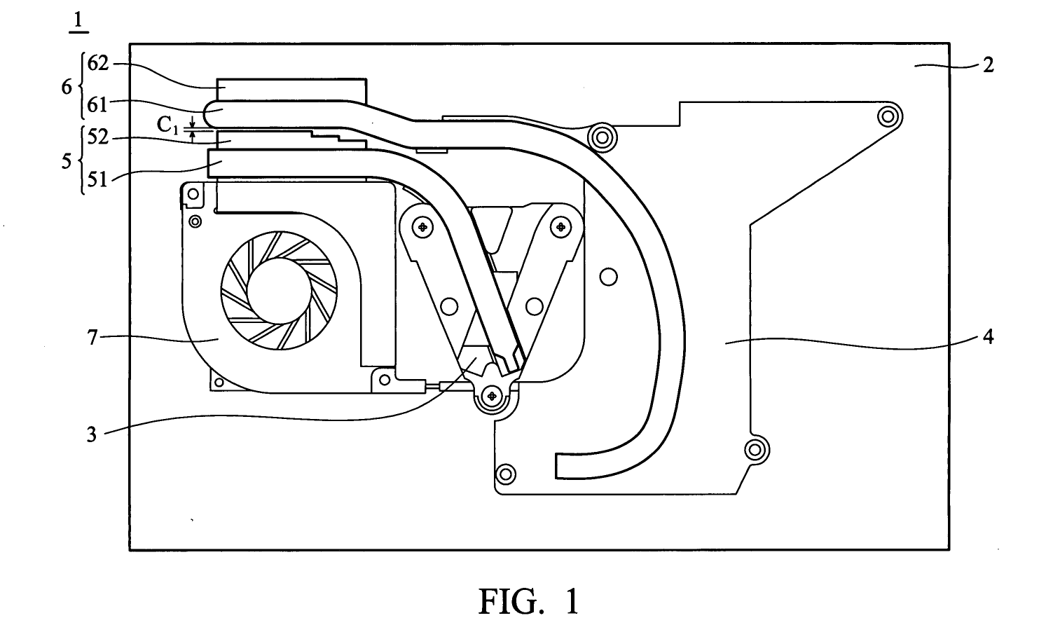

Referring to FIG. 1, an embodiment of an electronic device 1 comprises a circuit board 2, a central processing unit 3, a chipset 4, a first heat dissipation module 5, a second heat dissipation module 6, and a fan 7.

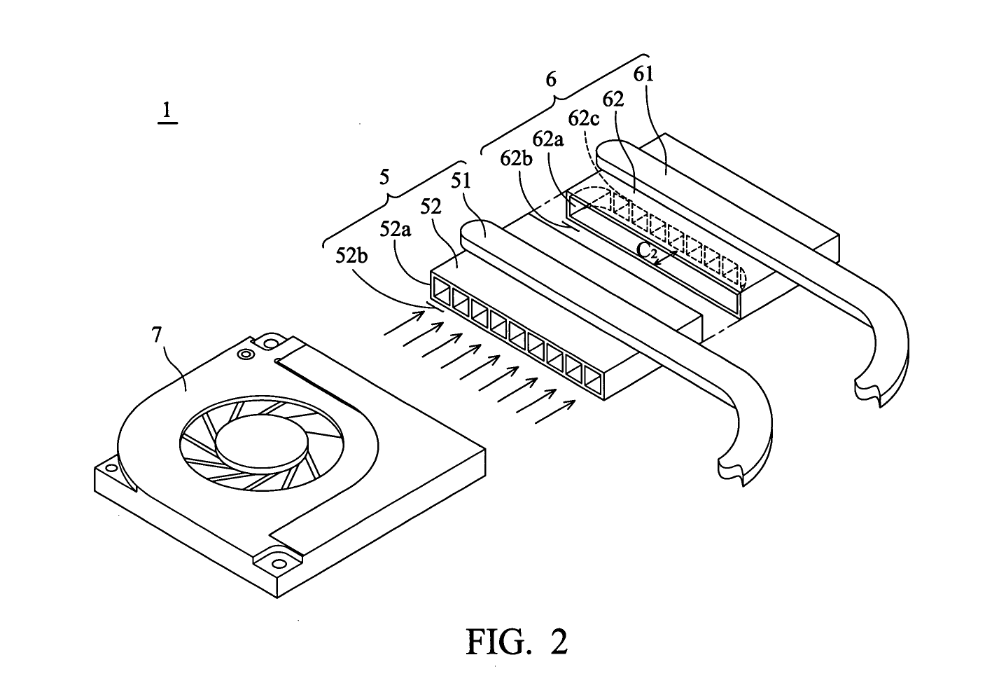

The central processing unit 3 and the chipset 4 are disposed on the circuit board 2. The first heat dissipation module 5 is disposed on the central processing unit 3, and comprises a first heat pipe 51 and a first heat exchanger 52. The first heat pipe 51 abuts the central processing unit 3, and is adhered to the first heat exchanger 52. Referring to FIG. 2, the first heat exchanger 52 comprises a plurality of first fins 52a. A first interval 52b is formed between any two adjacent first fins 52a.

Further referring to FIG. 1, the second heat dissipation module 6 is disposed on the chipset 4, and comprises a second heat pipe 61 and a second heat exchanger 62. The second heat pipe 62 abuts the chipset 4, and is adhered to the second heat exchanger 62. Referring to FIG. 2, the second heat exchanger 62 has a plurality of second fins 62a. A second interval 62b is formed between any two adjacent second fins 62a. The first intervals 52b of the first heat exchanger 52 are disposed opposite to the second intervals 62b of the second heat exchanger 62. In addition, the first heat exchanger 52 is disposed on the circuit board 2 next to the second heat exchanger 62. Thus, the first fins 52a are opposite to the second fins 62a. As shown in FIG. 1, the fan 7 is adjacent connected closely to the first heat dissipation module 52 and disposed on the circuit board 2.

Referring to FIG. 1 again, a minimum interval C1 exists between the first heat exchanger 52 and the second heat exchanger 62 due to installation tolerance considerations. Further, referring to FIG. 2, the second fins 62a are arranged to form an indentation 62c. The top view of the indentation 62c can be U-shaped. An interval C2 is formed by the indentation 62c between the first fins 52a and the second fins 62a.

When the electronic device 1 is used, heat generated by the central processing unit 3 is transmitted to the first heat pipe 51. The first heat pipe 51 then transmits heat to the first heat exchanger 52. A plurality of first fins 52a on the first heat exchanger 52 can further increase the dissipation area thereof. Heat generated by the chipset 4 is transmitted to the second heat exchanger 62 through the second heat pipe 61. Similarly, a plurality of second fins 62a on the second heat exchanger 62 can increase the dissipation area thereof.

When the fan 7 is operational, airflow from the fan 7 exhausts heat from the first fins 52a enhancing the heat dissipation efficiency. Airflow then passes through the minimum interval C1 and converges at the indentation 62c. Specifically, the airflow cut by the first fins 52a and converges again at the interval C2, reducing the boundary layer effect. Subsequently, airflow passes through the second fins 62a at a more uniform speed and exhausts heat from the second fins 62a, dissipating heat from the chipset 4. Thus, the invention requires only one fan 7 to dissipate heat from the central processing unit 3 and the chipset 4. The heat dissipation efficiency of the central processing unit 3 is enhanced, thus preventing damage to the electronic device 1. Additionally, the electronic device 1 with heat dissipation module is not only applicable to a notebook computer, but also can be applied to any other electronic device requiring two heat dissipation modules.

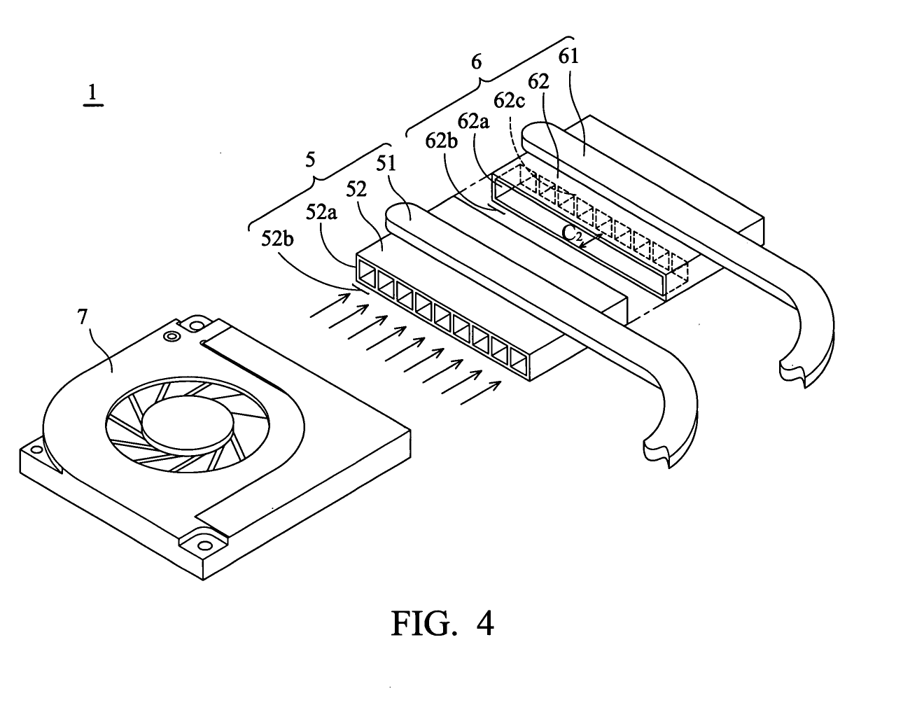

Note that the number and shape of the first fins 51a and the second fins 61a are not limited to that shown in FIG. 2 and FIG. 4.

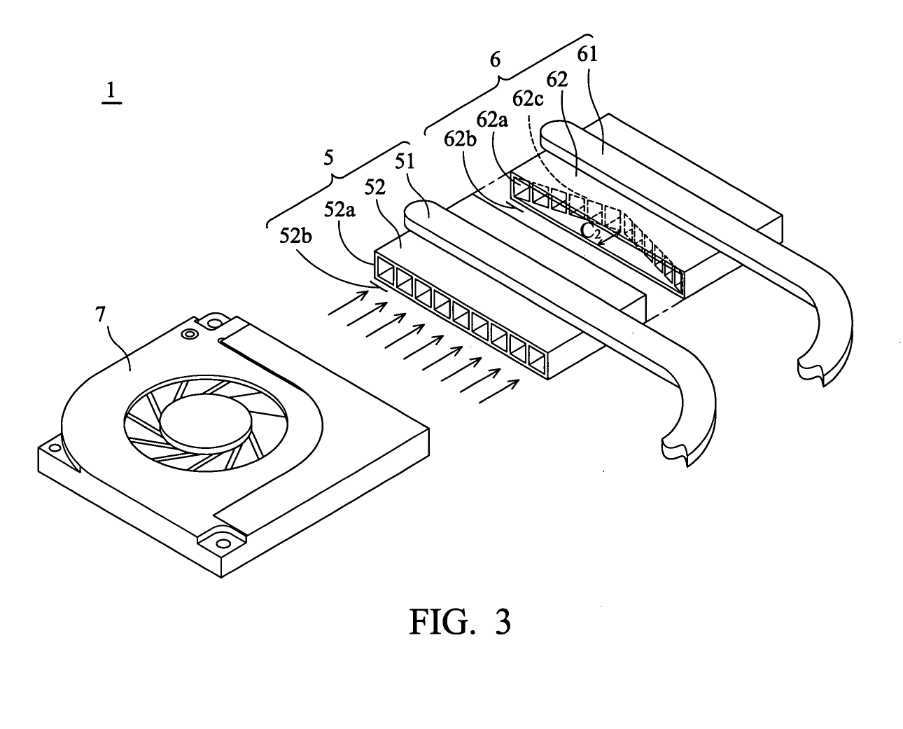

It should be noted that top view of the indentation 62c is not limited to that shown in FIG. 2, it can be V-shaped as shown in FIG. 3, or as shown in FIG. 4, the indentation 62c can be flat-shaped.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device with a heat dissipation module, comprising:
a circuit board;
a central processing unit disposed on the circuit board;
a chipset disposed on the circuit board;
a first heat dissipation module disposed on the central processing unit;
a second heat dissipation module disposed on the chipset; and
a fan disposed on the circuit board, wherein the fan abuts the first heat dissipation module, and the first heat dissipation module abuts the second heat dissipation module.

2. The electronic device as claimed in claim 1, wherein the first heat dissipation module comprises a first heat pipe and a first heat exchanger, and the second heat dissipation module comprises a second heat pipe and a second heat exchanger.

3. The electronic device as claimed in claim 2, wherein the first heat pipe abuts the central processing unit.

4. The electronic device as claimed in claim 2, wherein the first heat pipe connects to the first heat exchanger.

5. The electronic device as claimed in claim 4, wherein the first heat pipe is adhered to the first heat exchanger.

6. The electronic device as claimed in claim 2, wherein the second heat pipe abuts the chipset.

7. The electronic device as claimed in claim 6, wherein the second heat pipe connects to the heat exchanger.

8. The electronic device as claimed in claim 7, wherein the second heat pipe is adhered to the heat exchanger.

9. The electronic device as claimed in claim 2, wherein the first heat exchanger comprises a plurality of the first heat fins, and the second heat exchanger comprises a plurality of the second fins.

10. The electronic device as claimed in claim 9, further comprising a first interval between any two adjacent first fins and a second interval between any two adjacent second fins, the first interval corresponding to the second interval.

11. The electronic device as claimed in claim 9, wherein the second fins of the second heat exchanger are arranged to form an indentation, which forms a gap between the first fins and the second fins.

12. The electronic device as claimed in claim 11, wherein a top view of the indentation is a U-shaped.

13. The electronic device as claimed in claim 11, wherein a top view of the indentation is a V-shaped.

14. The electronic device as claimed in claim 1, wherein the electronic device is a notebook computer.
